(19) United States
(12) Patent Application Publication
(10) Pub. No.: US 2025/0101902 A1
(43) Pub. Date: Mar. 27, 2025

(54) RESERVOIR TANK ASSEMBLY AND A HEAT PUMP SYSTEM INCLUDING THE SAME

(71) Applicants: HYUNDAI MOTOR COMPANY, Seoul (KR); KIA CORPORATION, Seoul (KR)

(72) Inventors: Hyunjae Lee, Yongin-si (KR); Seong-Bin Jeong, Hwaseong-si (KR); Chan Woong Jo, Yongin-si (KR); Bugyeom Kim, Pohang-si (KR); Yong Woong Cha, Yongin-si (KR); Myunghwan Kim, Hwaseong-si (KR)

(73) Assignees: HYUNDAI MOTOR COMPANY, Seoul (KR); KIA CORPORATION, Seoul (KR)

(21) Appl. No.: 18/517,582

(22) Filed: Nov. 22, 2023

(30) Foreign Application Priority Data
Sep. 26, 2023 (KR) 10-2023-0128730

(51) Int. Cl. F01P 11/02; F01P 5/10

(52) U.S. Cl. CPC F01P 11/028; F01P 11/029; F01P 2005/105

(57) ABSTRACT

A reservoir tank assembly may include a housing in which a degassing chamber configured to store coolant is formed, an inlet piping formed in the housing and into which coolant flows, an outlet piping formed in the housing and through which coolant is discharged, and a connection duct fluidly connecting the inlet piping and the outlet piping. The connection duct is disposed through the degassing chamber. Some coolant flowing through the inlet piping flows into the connection duct after passing through the degassing chamber, and remaining coolant is discharged outside of the housing without passing through the degassing chamber.

### CROSS-REFERENCE TO RELATED APPLICATION

This application claims priority to and the benefit of Korean Patent Application No. 10-2023-0128730, filed in the Korean Intellectual Property Office on Sep. 26, 2023, the entire contents of which is incorporated herein by reference.

### BACKGROUND

### (a) Field

The present disclosure relates to a reservoir tank assembly and a heat pump system including the reservoir tank assembly.

### (b) Description of the Related Art

In general, an air conditioning apparatus applied to an environment-friendly vehicle is commonly referred to as a heat pump system.

Such a heat pump system for a vehicle is provided with a reservoir tank to cope with a change in the volume of the coolant according to a change in the temperature of the coolant. When the coolant is heated and its volume expands, some of the coolant is temporarily stored in the reservoir tank. When the coolant is cooled and the volume is reduced, the coolant stored in the reservoir tank is replenished to the cooling line.

Air may be contained inside the coolant due to heating and cooling of the coolant, and when an excessive amount of air is contained in the coolant, cooling efficiency by the coolant decreases and the volume of coolant in the entire heat pump system increases. In addition, when the coolant flows, noise is generated due to the air contained in the coolant, which adversely affects the blades of the coolant pump.

Increasing the capacity of the reservoir tank would solve this problem, but it also increases the volume of the reservoir tank and adversely affects vehicle packaging.

The matters described in this Background section are provided to only enhance the understanding of the present disclosure, and may include matters that are not already known to those of having ordinary skill in the art to which the present technology pertains.

### SUMMARY

The present disclosure provides a reservoir tank and a heat pump system including the same capable of removing air contained in the coolant.

In an embodiment of the present disclosure, a reservoir tank assembly may include: a housing in which a degassing chamber configured to store coolant is formed, and an inlet piping formed in the housing and into which coolant flows. The reservoir tank assembly may further include: an outlet piping formed in the housing and through which coolant is discharged, and a connection duct fluidly connecting the inlet piping and the outlet piping and disposed through the degassing chamber. In particular, some coolant flowing through the inlet piping flows into the connection duct after passing through the degassing chamber, and remaining coolant is discharged outside of the housing without passing through the degassing chamber.

In one embodiment, the housing may include a lower housing, and an upper housing provided above the lower housing, and the lower housing and the upper housing cooperatively form the degassing chamber.

In one embodiment, the connection duct may include a duct inlet formed in the connection duct, and a duct outlet that is formed in the connection duct and provided below the duct inlet.

In one embodiment, the connection duct may further include an inlet duct fluidically connected to the inlet piping, and an outlet duct that is partially connected to the inlet duct and fluidically connected to the outlet piping.

The duct inlet may be formed by an interval between the inlet duct and the outlet duct.

The duct outlet may be formed by an interval between an inner lower surface of the housing and the inlet duct.

In one embodiment, a portion of coolant drawn into an inlet duct through the inlet piping may flow into the degassing chamber through a duct hole, and remaining coolant drawn into the inlet duct and the coolant having passed through the degassing chamber may be discharged to the outlet piping through the outlet duct. The coolant discharged to the outlet piping may be supplied to the coolant line.

In another embodiment, a heat pump system may include: a coolant line through which coolant flows, an inlet piping branching from a first end of the coolant line, an outlet piping branching from a second end of the coolant line, and a reservoir tank. The reservoir tank includes a housing formed with a degassing chamber therein, and a connection duct fluidly connecting the inlet piping and the outlet piping and passing though the degassing chamber. In particular, some of the coolant flowing through the inlet piping flows into the connection duct after passing through the degassing chamber, and remaining coolant is discharged outside of the housing without passing through the degassing chamber.

In one embodiment, the housing may include a lower housing, and an upper housing provided above the lower housing. In particular, the lower housing and the upper housing cooperatively form the degassing chamber.

In one embodiment, the connection duct may include a duct inlet formed in the connection duct, and a duct outlet that is formed in the connection duct and provided below the duct inlet.

In one embodiment, the connection duct may further include an inlet duct fluidically connected to the inlet piping, and an outlet duct that is partially connected to the inlet duct and fluidically connected to the outlet piping.

The duct inlet may be formed by an interval between the inlet duct and the outlet duct.

The duct outlet may be formed by an interval between an inner lower surface of the housing and the inlet duct.

In one embodiment, a portion of coolant drawn into the inlet duct through the inlet piping may flow into the degassing chamber through a duct hole, and remaining coolant drawn into the inlet duct and the coolant having passed through the degassing chamber may be discharged to the outlet piping through an outlet duct. The coolant discharged to the outlet piping may be supplied to the coolant line.

According to a reservoir tank assembly and a heat pump system including the same of the present disclosure, the air contained in the coolant flowing through the coolant line may be efficiently removed by disposing the reservoir tank and the coolant line in parallel.

By removing the air contained in the coolant, the cooling efficiency may be enhanced and the capacity of the reservoir tank may be decreased, thereby obtaining an advantageous effect in packaging the vehicle.

Other effects that may be obtained or predicted by an embodiment are explicitly or implicitly described in a detailed description of the present disclosure. In other words, various effects that are predicted according to embodiments are described in the following detailed description.

### BRIEF DESCRIPTION OF THE DRAWINGS

These drawings are for reference in describing embodiments of the present disclosure, and the technical spirit of the present disclosure should not be construed as being limited to the accompanying drawings.

FIG. 1 is a block diagram of a heat pump system including a reservoir tank assembly according to an embodiment.

FIG. 2 is a schematic view showing a reservoir tank assembly applied to a coolant line according to an embodiment.

FIG. 3 is a perspective view illustrating a reservoir tank assembly according to an embodiment.

FIG. 4 is a cross-section perspective view of a reservoir tank assembly according to an embodiment.

FIG. 5 is a cross-sectional view of a reservoir tank assembly according to an embodiment.

FIG. 6 is a perspective view illustrating a lower housing 330 according to an embodiment.

FIG. 7 is a cross-section perspective view a lower housing 330 according to an embodiment.

FIG. 8 is a perspective view of an upper housing 320 according to an embodiment.

FIG. 9 is a cross-section perspective view of an upper housing 320 according to an embodiment.

It should be understood that the above-referenced drawings are not necessarily to scale, presenting a somewhat simplified representation of various features illustrative of the basic principles of the disclosure. The specific design features of the present disclosure, including, for example, specific dimensions, orientations, locations, and shapes, should be determined in part by the particular intended application and use environment.

### DETAILED DESCRIPTION

The terminology used herein is for the purpose of describing particular embodiments only and is not intended to be limiting of the present disclosure. As used herein, the singular forms are intended to include the plural forms as well, unless the context clearly indicates otherwise. It should be further understood that the terms “comprises” and/or “comprising,” when used in the present disclosure, specify the presence of stated features, integers, steps, operations, elements, and/or components, but do not preclude the presence or addition of one or more other features, integers, steps, operations, elements, components, and/or groups thereof. As used herein, the term “and/or” includes any one or all combinations of one or more related items.

The present disclosure is described more fully hereinafter with reference to the accompanying drawings, in which embodiments of the disclosure are illustrated. As those of having ordinary skill in the art would realize, the described embodiments may be modified in various different ways, all without departing from the spirit or scope of the present disclosure.

The drawings and description are to be regarded as illustrative in nature and not restrictive, and like reference numerals designate like elements throughout the present disclosure.

In addition, the size and thickness of each configuration shown in the drawings are arbitrarily shown for understanding and ease of description, but the present disclosure is not limited thereto, and the thickness of layers, films, panels, regions, etc., are exaggerated for clarity.

Suffixes, “module” and/or “unit” for a constituent element used for the description below are given or mixed in consideration of only easiness of the writing of the present disclosure, and the suffix itself does not have a discriminated meaning or role. When a component, device, element, or the like of the present disclosure is described as having a purpose or performing an operation, function, or the like, the component, device, or element should be considered herein as being “configured to” meet that purpose or to perform that operation or function.

Further, in describing the embodiments in the present disclosure, when it is determined that detailed description relating to well-known functions or configurations may make the subject matter of the embodiments of the present disclosure unnecessarily ambiguous, the detailed description has been omitted.

Further, the accompanying drawings are provided for helping to easily understand the embodiments disclosed in the present disclosure, and the technical spirit disclosed in the present disclosure is not limited by the accompanying drawings. It should be appreciated that the present disclosure includes all of the modifications, equivalent matters, and substitutes included in the spirit and the technical scope of the present disclosure.

According to an embodiment of the present disclosure, a heat pump system, to which a reservoir tank assembly is applied, is described in detail with reference to the accompanying drawings.

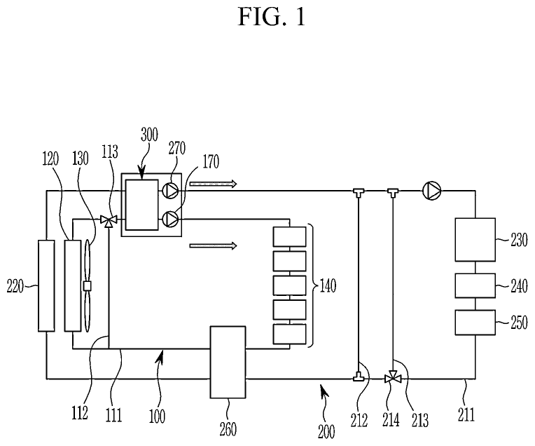

FIG. 1 is a block diagram of a heat pump system including a reservoir tank assembly according to an embodiment.

As shown in FIG. 1, the heat pump system, to which the reservoir tank assembly 300 is applied, may include a first cooling circuit 100 configured to cool at least one electrical component 140, and a second cooling circuit 200 configured to cool a battery. In the present disclosure, a heat pump system applied to an electric vehicle is described as an example, but the scope of the present disclosure is not limited thereto.

In one embodiment, the first cooling circuit 100 may include a first radiator 120, the reservoir tank assembly 300, and the electrical component(s) 140 that are provided in a first coolant line 111 through which the coolant flows. The first radiator 120, the reservoir tank assembly 300, and the electrical component 140 may be sequentially disposed in the first coolant line 111.

In one embodiment, the second cooling circuit 200 may include a second radiator 220, the reservoir tank assembly 300, a battery module 230, a battery heater 240, and a battery chiller 250 that are provided in a second coolant line 211 through which the coolant flows. The second radiator 220, the reservoir tank assembly 300, the battery module 230, the battery heater 240, and the battery chiller 250 may be sequentially disposed in the second coolant line 211.

As illustrated in FIG. 1, the reservoir tank assembly 300 is provided to overlap the first coolant line 111 and the second coolant line 211. In other words, the first and second cooling circuits 100, 200 share the reservoir tank assembly 300. The coolant cooled by the first radiator 120 is stored inside housing of the reservoir tank assembly 300 through the first coolant line 111, and the coolant cooled by the second radiator 220 is stored inside housing of the reservoir tank assembly 300 through the second coolant line 211. Alternatively, a reservoir tank assembly 300 may also be provided in each of the first coolant line 111 and the second coolant line 211.

In one embodiment, in the first coolant line 111, a first water pump 170 is provided on a downstream side of the reservoir tank assembly 300, and a second water pump 270 is also provided on the downstream side of the reservoir tank assembly 300 in the second coolant line 211. The coolant stored in a reservoir tank of the reservoir tank assembly 300 is supplied to the first coolant line 111 by an operation of the first water pump 170, and supplied to the second coolant line 211 by an operation of the second water pump 270. In one form of the present disclosure, the reservoir tank assembly 300, the first water pump 170, and the second water pump 270 may be integrated (or, formed integral).

The first cooling circuit 100 is described in more detail.

The first radiator 120 is disposed at a front of the vehicle, and a cooling fan 130 is provided behind it to cool the coolant flowing through the first coolant line 111 through the operation of the cooling fan 130 and heat-exchange with ambient air.

The electrical component(s) 140 may include at least one of an electric power control apparatus, an inverter, a power conversion device such as an on-board charger (OBC), a drive motor, or an autonomous driving controller. The electric power control apparatus, the inverter, or the autonomous driving controller may generate heat while driving, the on-board charger may generate heat when charging the battery. The electrical component 140 may be provided in the first coolant line 111 and cooled by water-cooling.

In one embodiment, a first branch line 112 may be provided in the first cooling circuit 100. The first branch line 112 may branch from an upstream section of the first coolant line 111 and join to a downstream section of the first coolant line 111, while bypassing the first radiator 120. A first valve 113 may be provided at a point where the first branch line 112 and the first coolant line 111 join. The first valve 113 may be implemented as a 3-way valve.

The coolant flowing through the first coolant line 111 is selectively supplied to the first radiator 120 by an operation of the first valve 113. For example, when it is necessary to cool the electrical component(s) 140, the first valve 113 is operated to open the first coolant line 111 while closing the first branch line 112, such that the coolant cools the electrical components 140 and the heated coolant by heat-exchange with the electrical components 140 is cooled while passing through the first radiator 120. To the contrary, when it is not necessary to cool the electrical component(s) 140 by the coolant cooled by the first radiator 120, by the operation of the first valve 113, the first coolant line 111 passing through the first radiator 120 is closed and the first branch line 112 and the first coolant line 111 fluidly communicate with each other, such that the coolant is not supplied to the first radiator 120.

The second cooling circuit 200 is described in further detail.

The second radiator 220 is disposed in front of the first radiator 120, and cools the coolant flowing through the second coolant line 211 through the operation of the cooling fan 130 and heat-exchange with the ambient air. If necessary, the first radiator 120 and the second radiator 220 may also be integrally configured.

The second cooling circuit 200 may selectively supply the coolant cooled at the second radiator 220 to the battery module 230.

The battery heater 240 heats the battery module 230, if necessary. The battery heater 240 may be an electric heater operated with electrical power. For example, the battery heater 240 operates when a temperature of the coolant supplied to the battery module 230 is lower than a target temperature, and may heat the coolant flowing through the second coolant circuit. Accordingly, the coolant heated while passing through the battery heater 240 is supplied to the battery module 230, and may increase a temperature of the battery module 230.

The battery chiller 250 cools the battery module 230, if necessary. The battery chiller 250 may decrease the temperature of the coolant drawn through the second coolant line 211 through heat-exchange with refrigerant. The low-temperature coolant heat-exchanged with refrigerant at the battery chiller 250 may flow to the battery module 230 and cool the battery module 230.

In one embodiment, a second branch line 212 and a third branch line 213 may be provided in the second cooling circuit 200. The second branch line 212 may branch from an upstream section of the second coolant line 211 and join to a downstream section of the second coolant line 211, while bypassing the second radiator 220. The third branch line 213 may branch from another downstream section of the second coolant line 211, which is on a downstream side of the battery chiller 250, and join to another upstream section of the second coolant line 211, which is on an upstream side of the battery module 230. A second valve 214 may be provided at a point where the third branch line 213 and the second coolant line 211 join. The second valve 214 may be implemented as a 3-way valve.

The coolant flowing through the second coolant line 211 is selectively supplied to the second radiator 220 by an operation of the second valve 214.

For example, when it is desired to cool the battery module 230 by the coolant cooled by the second radiator 220, by the operation of the second valve 214, a coolant flow from the second coolant line 211 to the third branch line 213 is blocked and the second coolant line 211 passing through the second radiator 220 is opened, such that the coolant heated by heat-exchange with the battery module 230 is cooled through the second radiator 220.

To the contrary, when it is not necessary to cool the battery module 230 by the coolant cooled by the second radiator 220, by the operation of the second valve 214, a coolant flow along the second coolant line 211 passing through the second radiator 220 is blocked and the third branch line 213 and the second coolant line 211 fluidly communicate with each other, such that the coolant is not supplied to the second radiator 220. In this case, the second cooling circuit 200 forms two closed circuits. In other words, one closed circuit circulating the second radiator 220, the reservoir tank assembly 300, and the second water pump 270, and another circuit circulating the battery module 230, the battery heater 240, and the battery chiller 250 are formed.

In one embodiment, a water-cooled heat-exchanger 260 may be provided to overlap the first coolant line 111 and the second coolant line 211. By the water-cooled heat-exchanger 260, the coolant flowing through the first coolant line 111 and the coolant flowing through the second coolant line 211 may heat-exchange with each other.

Hereinafter, the reservoir tank assembly 300 is described in detail with reference to the accompanying drawings.

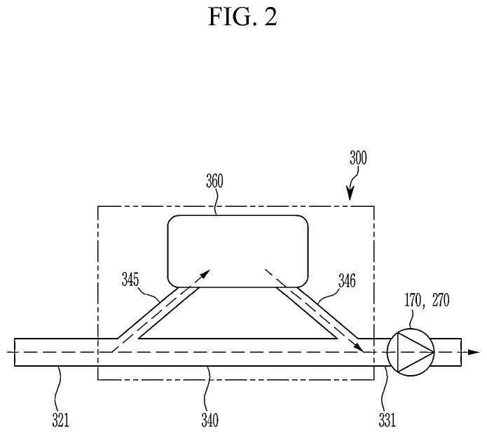

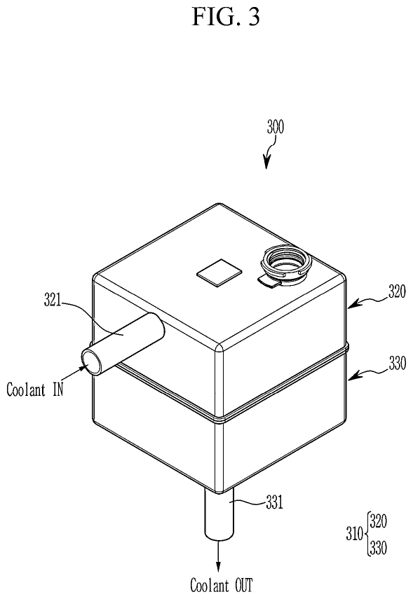

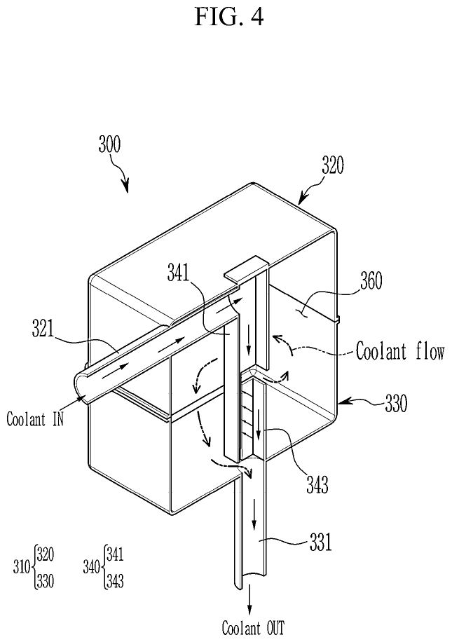

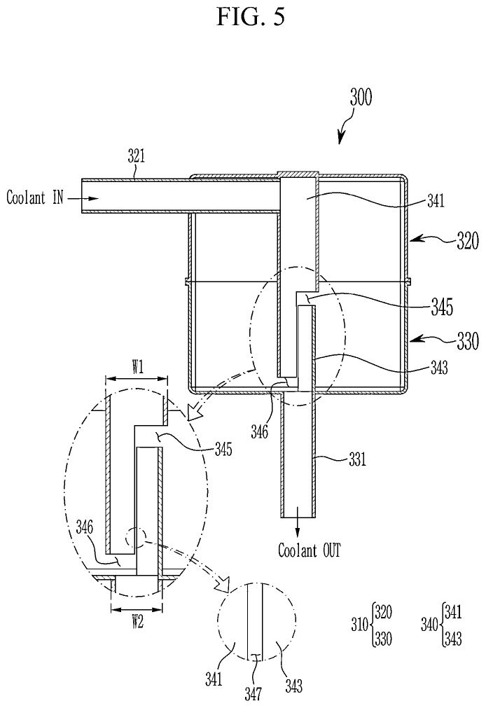

FIG. 2 is a schematic view showing a configuration in which a reservoir tank assembly according to an embodiment is applied to a coolant line. FIG. 3 is a perspective view illustrating a reservoir tank assembly according to an embodiment. FIG. 4 is a cross-section perspective view of a reservoir tank assembly according to an embodiment. In addition, FIG. 5 is a cross-sectional view of a reservoir tank assembly according to an embodiment.

Referring to FIG. 2, a degassing chamber 360 formed in the reservoir tank assembly 300 is disposed in parallel to a connection duct 340 in a housing 310. Some coolant flowing into the connection duct 340 fluidly connected to the coolant line from the coolant line reflows into the connection duct 340 after passing through the degassing chamber 360. And remaining coolant flowing into the connection duct 340 flows through the connection duct 340 and is exhausted to outside of the reservoir tank assembly 300 without passing through the degassing chamber 360.

Referring to FIG. 3 to FIG. 5, the reservoir tank assembly 300 may include a housing 310 forming a space (e.g., a degassing chamber 360) storing the coolant, an inlet piping 321 formed in the housing 310 and into which coolant flows, and an outlet piping 331 formed in the housing 310 and through which coolant is discharged. The inlet piping 321 is branched off from the coolant line, and fluidly connects the coolant line and the housing. And the outlet piping 331 is branched off from the coolant line, and fluidly connects the coolant line and the housing 310. The degassing chamber 360 and the connection duct 340 configured to remove air contained in the coolant are formed inside the housing 310.

The housing 310 may include a lower housing 330 and an upper housing 320 provided on above the lower housing 330. The lower housing 330 and the upper housing 320 cooperatively form the degassing chamber 360 therein.

A connection duct 340 fluidically connected to the inlet piping 321 and the outlet piping 331 is provided inside the housing 310. The connection duct 340 fluidly connecting the coolant line through the inlet piping 321 and the outlet piping 331 may be disposed through the degassing chamber 360. The duct outlet 346 is disposed below the duct inlet 345. The connection duct 340 includes an inlet duct 341 fluidically connected to the inlet piping 321, and an outlet duct 343 partially and fluidically connected to the outlet piping 331 and fluidically connected to the outlet piping 331. The duct inlet 345 and the duct outlet 346 are formed in the inlet piping 321 and the outlet piping 331. By the duct inlet 345 and the duct outlet 346, the inlet duct 341 and the outlet duct 343 are partially and fluidically connected to each other. The inlet duct 341 and the outlet duct 343 may be vertically disposed inside the housing 310.

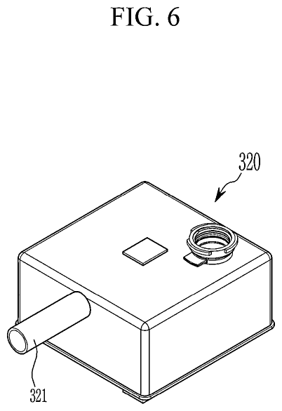

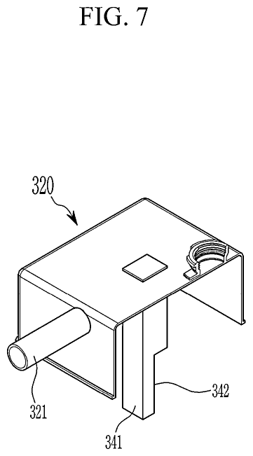

Referring to FIG. 6 and FIG. 7, the upper housing 320 is formed in a generally hexahedron shape having a hollow interior, and has an open bottom. The inlet piping 321 is provided on a side surface of the upper housing 320, and the inlet duct 341 fluidically connected to the inlet piping 321 is provided on an upper inner side of the upper housing 320. The inlet duct 341 may be formed to vertically extend from the upper inner side of the upper housing 320.

The inlet duct 341 may be formed in a generally hexahedron shape having a hollow interior. An inlet incision 342 that is partially cut out is formed in a lower portion of the inlet duct 341. A lower end of the inlet duct 341 are spaced apart from an inner lower surface of the lower housing 330 by a preset interval to form the duct outlet 346.

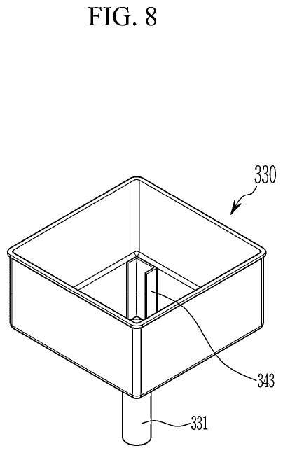

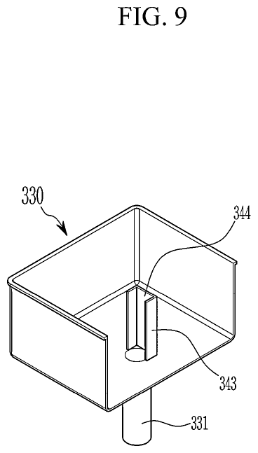

Referring to FIG. 8 and FIG. 9, the lower housing 330 is formed in a generally hexahedron shape having a hollow interior, and has an open top. The outlet duct 343 partially and fluidically connected to the inlet duct 341 is provided in a lower inner side of the lower housing 330, and the outlet piping 331 fluidically connected to the outlet duct 343 is provided on a lower portion of the lower housing 330. The outlet duct 343 may be formed to vertically extend from the lower inner side of the lower housing 330.

The outlet duct 343 may correspond to the inlet duct 341, and may be formed in a generally hexahedron shape having a hollow interior. An outlet incision 344 is partially cut out and formed in an upper portion of the outlet duct 343.

The inlet incision 342 and the outlet incision 344 are formed in shapes corresponding to each other, and a lower portion of the inlet incision 342 and an upper portion of the outlet incision 344 are spaced apart by a preset interval to form the duct inlet 345.

In one embodiment, the inlet incision 342 and the outlet incision 344 are spaced apart from each other by a preset interval in a direction perpendicular to a length direction, to form a duct intermediate passage 347. In addition, a width W1 of the inlet duct 341 may be wider than a width W2 of the outlet duct 343.

Because the width W1 of the inlet duct 341 is wider than the width W2 of the outlet duct 343, the duct inlet 345 may be substantially increased. With this configuration, the amount of coolant supplied from the inlet duct 341 to the degassing chamber 360 through the duct inlet 345 may be increased.

In addition, because the duct intermediate passage 347 is formed, the coolant may be smoothly supplied from the inlet duct 341 to the degassing chamber 360.

Hereinafter, the flow of coolant by the reservoir tank assembly 300 according to the present disclosure is described.

All coolant flowing along the coolant line flows into the inlet duct 341 of the housing 310 through the inlet piping 321.

A portion of the coolant drawn into the inlet duct 341 is introduced into the degassing chamber 360 through the duct inlet 345. Remaining portion of the coolant drawn into the inlet duct 341 is supplied to the coolant line through the outlet duct 343 and the outlet piping 331.

Regarding the coolant drawn into the degassing chamber 360, during the process of passing through the degassing chamber 360, the flow speed of the coolant is decreased, and the turbulence intensity of the coolant is decreased. Because the flow speed and the turbulence intensity of the coolant is decreased, the air contained in the coolant is discharged from the coolant.

The coolant having discharged the air is supplied to the coolant line through the duct outlet 346, the outlet duct 343, and the outlet piping 331.

As such, the air contained in the coolant may be smoothly removed by the degassing chamber 360 disposed in parallel to the connection duct 340, such that the specific heat of the coolant circulating the entire heat pump system is increased, and the cooling performance may be enhanced.

In addition, because the coolant from which the air is removed flows into the water pump, the NVH (noise, vibration, and harshness) of water pump may be improved.

In addition, because the air of the coolant is removed by disposing the connection duct 340 to be in parallel with the degassing chamber 360, the volume of the degassing chamber 360 of the reservoir tank assembly 300 may be minimized, thereby providing an advantage in the packaging of the vehicle.

Although the embodiments of the present disclosure have been described, the present disclosure is not limited thereto, and it is possible to carry out various modifications within the scope of the present disclosure, the detailed description of the disclosure, and the accompanying drawings, and the modifications belong to the scope of the present disclosure as a matter of course.

### DESCRIPTION OF SYMBOLS

100: first cooling circuit
111: first coolant line
112: first branch line
113: first valve
120: first radiator
130: cooling fan
140: electrical component(s)
170: first water pump
200: second cooling circuit
211: second coolant line
212: second branch line
213: third branch line
214: second valve
220: second radiator
230: battery module
240: battery heater
250: battery chiller
260: water-cooled heat-exchanger
270: second water pump
300: reservoir tank assembly
310: housing
320: upper housing
321: inlet piping
330: lower housing
331: outlet piping
340: connection duct
341: inlet duct
342: inlet incision
343: outlet duct
344: outlet incision
345: duct inlet
346: duct outlet
347: duct intermediate passage
360: degassing chamber

What is claimed is:

1. A reservoir tank assembly, comprising:
a housing in which a degassing chamber configured to store coolant is formed;
an inlet piping formed in the housing and into which coolant flows;
an outlet piping formed in the housing and through which coolant is discharged; and
a connection duct fluidly connecting the inlet piping and the outlet piping, and disposed through the degassing chamber; and
wherein some coolant flowing through the inlet piping flows into the connection duct after passing through the degassing chamber, and remaining coolant is discharged outside of the housing without passing through the degassing chamber.

2. The reservoir tank assembly of claim 1, wherein the housing comprises:
a lower housing; and
an upper housing provided above the lower housing,
wherein the lower housing and the upper housing cooperatively form the degassing chamber.

3. The reservoir tank assembly of claim 1,
wherein the connection duct comprises:
a duct inlet formed in the connection duct; and
a duct outlet formed in the connection duct and provided below the duct inlet.

4. The reservoir tank assembly of claim 3, wherein the connection duct further comprises:
an inlet duct fluidically connected to the inlet piping; and
an outlet duct partially connected to the inlet duct and fluidically connected to the outlet piping.

5. The reservoir tank assembly of claim 4, wherein the duct inlet is formed by an interval between the inlet duct and the outlet duct.

6. The reservoir tank assembly of claim 4, wherein the duct outlet is formed by an interval between an inner lower surface of the housing and the inlet duct.

7. The reservoir tank assembly of claim 4, wherein:
a portion of coolant drawn into an inlet duct through the inlet piping flows into the degassing chamber through a duct hole;
remaining coolant drawn into the inlet duct and the coolant having passed through the degassing chamber is discharged to the outlet piping through the outlet duct; and
the coolant discharged to the outlet piping is supplied to a coolant line.

8. A heat pump system, comprising:
a coolant line through which coolant flows;
an inlet piping branching from a first end of the coolant line;
an outlet piping branching from a second end of the coolant line; and
a reservoir tank comprising a housing formed with a degassing chamber therein, and a connection duct fluidly connecting the inlet piping and the outlet piping and passing though the degassing chamber,
wherein some of the coolant flowing through the inlet piping flows into the connection duct after passing through the degassing chamber, and remaining coolant is discharged outside of the housing without passing through the degassing chamber.

9. The heat pump system of claim 8, wherein the housing comprises:
a lower housing; and
an upper housing provided above the lower housing,
wherein the lower housing and the upper housing cooperatively form the degassing chamber.

10. The heat pump system of claim 9, wherein the connection duct comprises:
a duct inlet formed in the connection duct; and
a duct outlet formed in the connection duct and provided below the duct inlet.

11. The heat pump system of claim 10, wherein the connection duct comprises:
an inlet duct fluidically connected to the inlet piping; and
an outlet duct partially connected to the inlet duct and fluidically connected to the outlet piping.

12. The heat pump system of claim 11, wherein the duct inlet is formed by an interval between the inlet duct and the outlet duct.

13. The heat pump system of claim 11, wherein the duct outlet is formed by an interval between an inner lower surface of the housing and the inlet duct.

14. The heat pump system of claim 11, wherein:
a portion of coolant drawn into the inlet duct through the inlet piping flows into the degassing chamber through a duct hole;
remaining coolant drawn into the inlet duct and the coolant having passed through the degassing chamber is discharged to the outlet piping through the outlet duct; and
the coolant discharged to the outlet piping is supplied to the coolant line.
